(19) United States
(12) Patent Application Publication
(10) Pub. No.: US 2016/0375559 A1
(43) Pub. Date: Dec. 29, 2016

(54) Open-end wrench capable of locking and unlocking hexagonal nut continuously

(71) Applicant: Wei-Ming LAI, Taichung City (TW)

(72) Inventor: Wei-Ming LAI, Taichung City (TW)

(21) Appl. No.: 15/131,052

(22) Filed: Apr. 18, 2016

(30) Foreign Application Priority Data
Jun. 23, 2015 (TW) 104209976

(51) Int. Cl. B25B 13/12; B25B 13/46

(52) U.S. Cl. CPC B25B 13/12; B25B 13/46

(57) ABSTRACT

An open-end wrench is capable of locking and unlocking a hexagon nut continuously and contains: a holder, a driving head, a returning spring, and a handle. The holder is configured to accommodate the driving head, the returning spring, and an actuation shaft. The holder includes a first jaw, a body, and an accommodation cavity, wherein the accommodation cavity has a first panel, the holder further includes a first orifice for accommodating a first post, a second orifice for housing a second post, and a third orifice for accommodating a third post. The driving head includes a second jaw and an extension which has a second panel, a slot, a trench, and a projection. The returning spring is accommodated in the slot, and the handle includes the actuation shaft, an operation shaft, a concaved portion, and a coupling hole.

### FIELD OF THE INVENTION

The present invention relates to an open-end wrench which is capable of locking and unlocking a hexagonal nut continuously.

### BACKGROUND OF THE INVENTION

A conventional open-end wrench contains a handle and a clamp head extending outwardly from the handle, wherein the clamp head has a first jaw, a second jaw corresponding to the first jaw, and a cutout defined between the first jaw and the second jaw so as to fit with a hexagonal nut, such that the first jaw and the second jaw clamp two of six sides of the hexagonal nut parallel to each other, and after the handle is rotated clockwise or counterclockwise, the hexagonal nut is locked or unlocked by the clamp head.

The first jaw is integrally formed with the second jaw, so a width of the cutout is fixed, and when the open-end wrench fits with the hexagonal nut, the cutout has to align with the two sides of the hexagonal nut. In other words, when at least one of six corners of the hexagonal nut contacts with the first jaw or the second jaw, it interferes rotation of the open-end wrench.

Furthermore, when the open-end wrench contacts an obstacle, the cutout of the open-end wrench has to be removed from the hexagonal nut and to be fitted with the hexagonal nut again, thus causing troublesome operation.

The present invention has arisen to mitigate and/or obviate the afore-described disadvantages.

### SUMMARY OF THE INVENTION

The primary objective of the present invention is to provide an open-end wrench which is capable of locking and unlocking a hexagonal nut continuously.

To obtain the above objective, an open-end wrench provided by the present invention contains: a holder, a driving head, a returning spring, and a handle.

The holder is configured to accommodate the driving head, the returning spring, and an actuation shaft on a front end of the handle, and the holder includes a first jaw extending outwardly from one side of a front end thereof, a body extending outwardly from on a rear end of the first jaw, and an accommodation cavity defined in the body, wherein the accommodation cavity has a first panel arranged therein, the holder further includes a first orifice passing through the body adjacent to the first jaw and includes a second orifice passing through the body away from the first jaw, wherein the first orifice accommodates a first post, and the second orifice houses a second post, the holder further includes a third orifice passing through a rear end of the body so as to accommodate a third post.

The driving head includes a second jaw extending outwardly from one side of a front end thereof, and the driving head also includes an extension arranged on a rear end of the second jaw, wherein the extension has a second panel formed thereon, a slot defined on a middle section thereof, a trench formed on a rear end thereof, and a projection extending outwardly from the rear end of the extension adjacent to the trench.

The returning spring is accommodated in the slot, and the handle includes the actuation shaft arranged on the front end thereof, an operation shaft formed on a rear end thereof, a concaved portion defined on a connection area of the actuation shaft and the operation shaft, and a coupling hole formed thereon proximate to the actuation shaft.

Preferably, a clamping space is defined between the first jaw and the second jaw, the actuation shaft is housed in the trench, and the projection is accommodated in the concaved portion.

Preferably, the first panel of the accommodation cavity accommodates and mates with the second panel of the extension, hence the second panel moves horizontally on the first panel.

### BRIEF DESCRIPTION OF THE DRAWINGS

FIG. 1 is a perspective view showing the assembly of an open-end wrench according to a preferred embodiment of the present invention.

FIG. 2 is a perspective view showing the exploded components of the open-end wrench according to the preferred embodiment of the present invention.

FIG. 3 is side plan views showing the operation of the open-end wrench according to the preferred embodiment of the present invention.

FIG. 4 is another side plan views showing the operation of the open-end wrench according to the preferred embodiment of the present invention.

FIG. 5 is also another side plan views showing the operation of the open-end wrench according to the preferred embodiment of the present invention.

FIG. 6 is still another side plan views showing the operation of the open-end wrench according to the preferred embodiment of the present invention.

FIG. 7 is another side plan views showing the operation of the open-end wrench according to the preferred embodiment of the present invention.

### DETAILED DESCRIPTION OF THE FIRST EMBODIMENTS

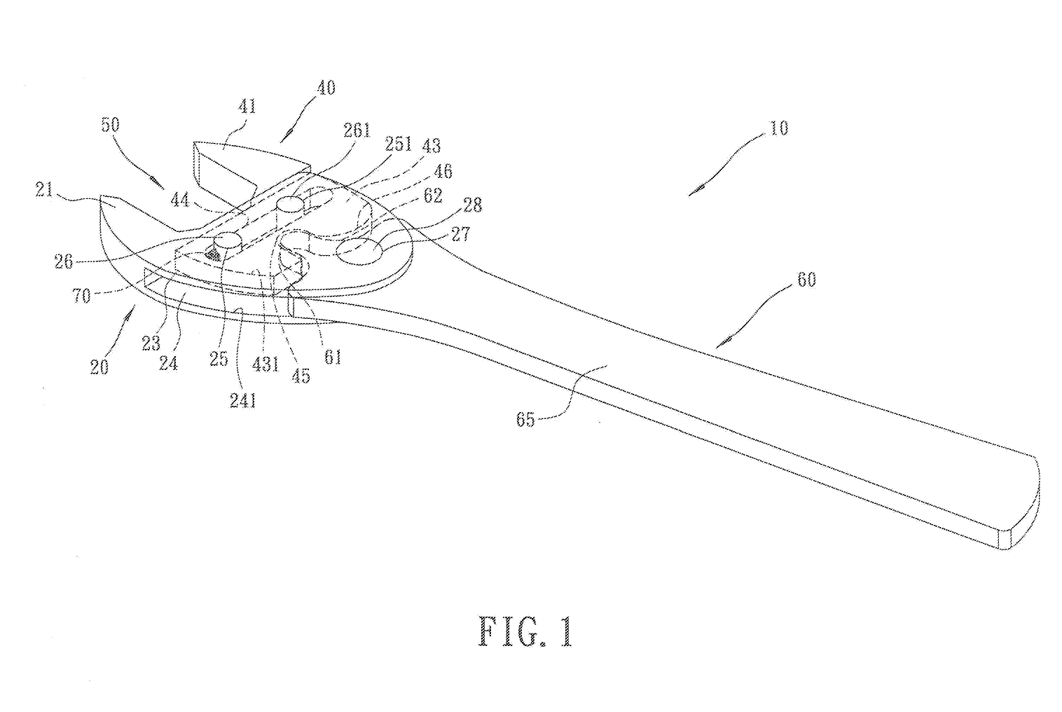

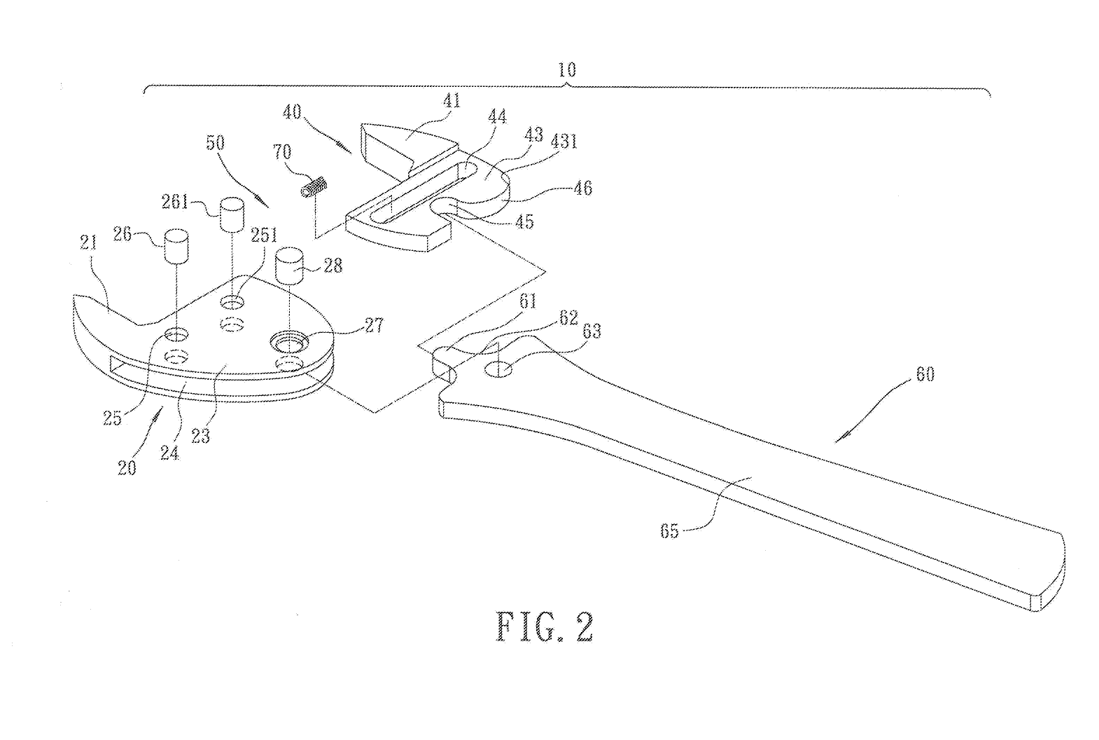

With reference to FIGS. 1 to 7, an open-end wrench 10 capable of locking and unlocking a hexagon nut continuously according to a preferred embodiment of the present invention comprises: a holder 20, a driving head 40, a returning spring 70, and a handle 60.

The holder 20 is configured to accommodate the driving head 40, the returning spring 70, and an actuation shaft 61 on a front end of the handle 60, and the holder 20 includes a first jaw 21 extending outwardly from one side of a front end thereof, a body 23 extending outwardly from on a rear end of the first jaw 21, and an accommodation cavity 24 defined in the body 23, wherein the accommodation cavity 24 has a first panel 241 arranged therein. The holder 20 further includes a first orifice 25 passing through the body 23 adjacent to the first jaw 21 and includes a second orifice 251 passing through the body 23 away from the first jaw 21, wherein the first orifice 25 accommodates a first post 26, and the second orifice 251 houses a second post 261. The holder 20 further includes a third orifice 27 passing through a rear end of the body 23 so as to accommodate a third post 28.

The driving head 40 includes a second jaw 41 extending outwardly from one side of a front end thereof and includes an extension 43 arranged on a rear end of the second jaw 41, wherein the extension 43 has a second panel 431 formed thereon, a slot 44 defined on a middle section thereof, a trench 45 formed on a rear end thereof, and a projection 46 extending outwardly from the rear end of the extension 43 adjacent to the trench 45.

The returning spring 70 is accommodated in the slot 44, and the handle 60 includes the actuation shaft 61 arranged on the front end thereof, an operation shaft 65 formed on a rear end thereof, a concaved portion 62 defined on a connection area of the actuation shaft 61 and the operation shaft 65, and a coupling hole 63 formed thereon proximate to the actuation shaft 61.

In assembly, a clamping space 50 is defined between the first jaw 21 and the second jaw 41, the actuation shaft 61 is housed in the trench 45, and the projection 46 is accommodated in the concaved portion 62. After rotating the handle 60, the second jaw 41 moves close to the first jaw 21 so as to reduce a width of the clamping space 50. Alternatively, the second jaw 41 moves away from the first jaw 21 after rotating the handle 60 so that the width of the clamping space 50 increases, and the first panel 241 of the accommodation cavity 24 accommodates and mates with the second panel 431 of the extension 43, hence the second panel 431 moves horizontally on the first panel 241.

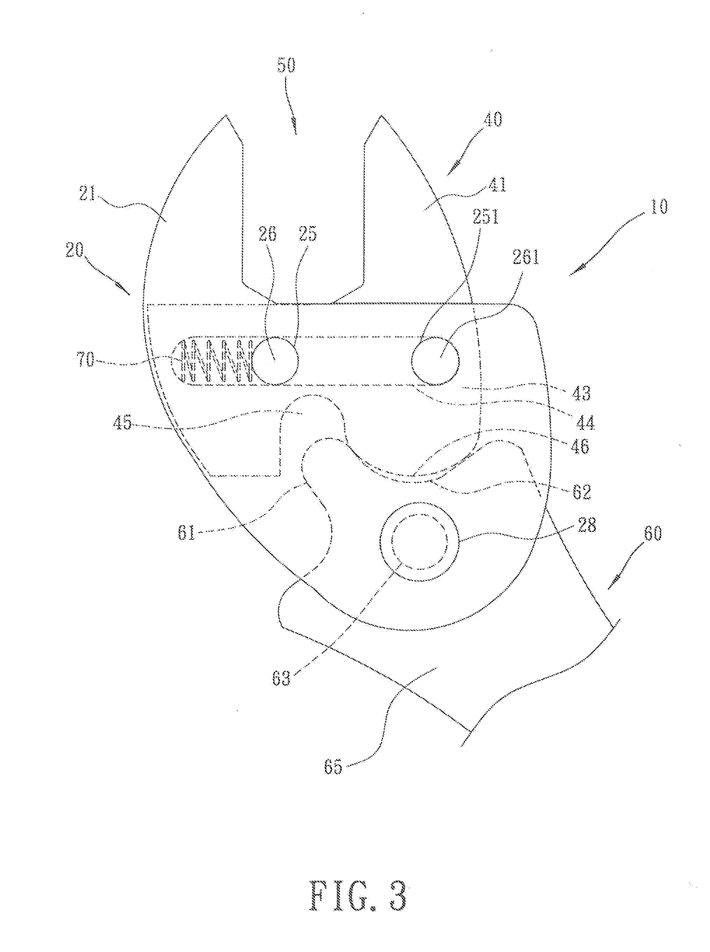

Referring to FIG. 3, in an unlocking state to the hexagonal nut, the first post 26 passes through the first orifice 25 and the second past 261 passes through the second orifice 251, wherein the slot 44 of the extension 43 connects with the holder 20 so that the clamping space 50 forms between the first jaw 21 and the second jaw 41, and a first end of the returning spring 70 pushes the slot 44, a second end of the returning spring 70 abuts against the first post 26, hence the second jaw 41 moves close to the second jaw 21 until the second post 261 retains with the slot 44. Thereafter, the actuation shaft 61 is housed in the trench 45, and the projection 46 is accommodated in the concaved portion 62.

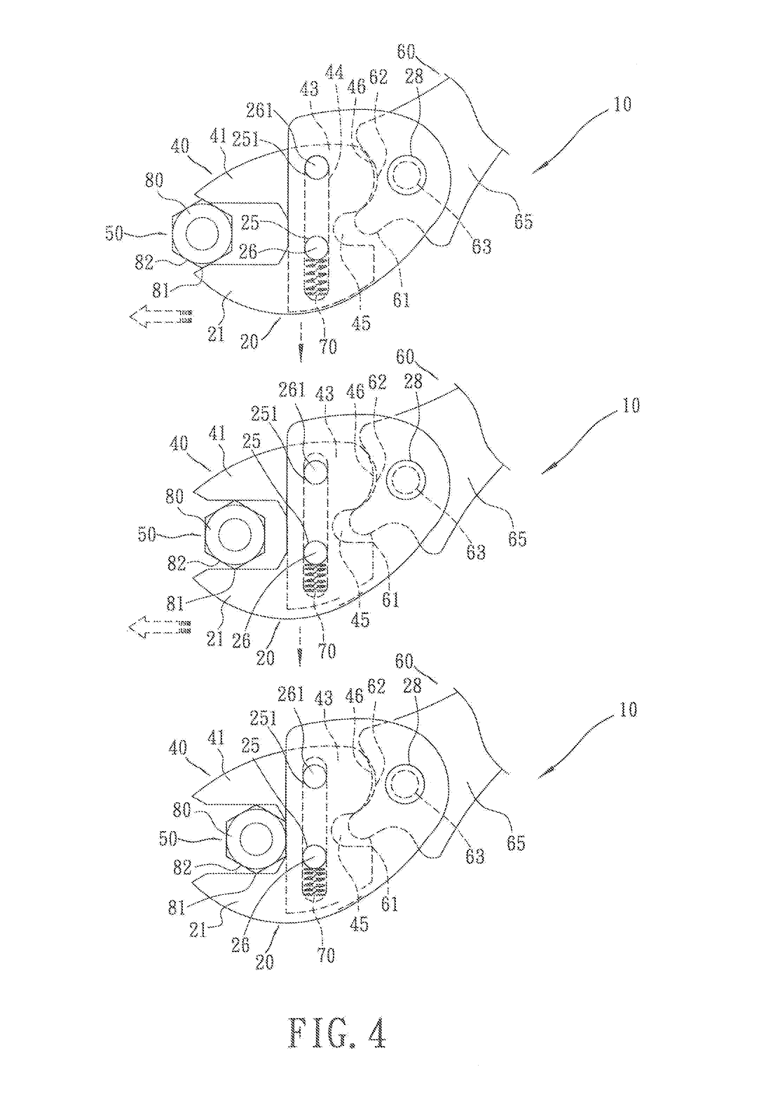

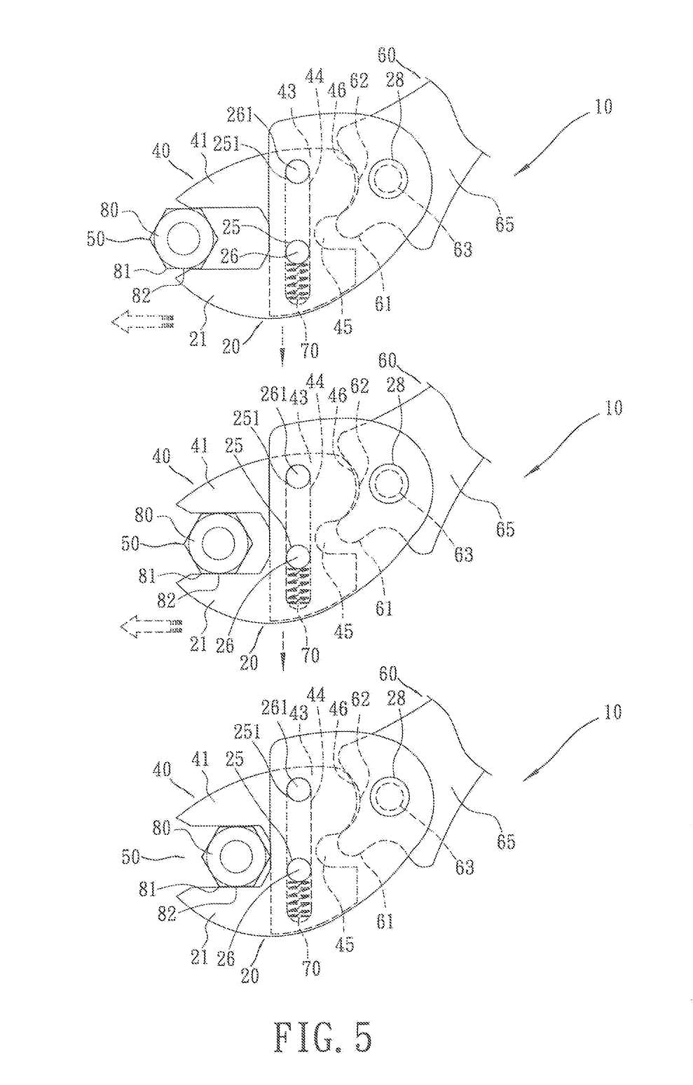

As shown in FIGS. 4 to 5, as the open-end wrench 10 fits with a corner 80 or a peripheral side 82 of the hexagonal nut 80, the returning spring 70 is forced by a distal end of the slot 44 and the first post 26 so as to drive the second jaw 41 to move rightward, wherein the corner 81 of the hexagonal nut 80 expands the width of the clamping space 50 so that when the corner 81 contacts with the first jaw 21 and the second jaw 41, the open-end wrench 10 fits with and locks or unlocks the hexagonal nut 80 smoothly. In other words, when the clamping space 50 fits with the hexagonal nut 80, the second jaw 41 moves rightward so as to adjust the width of the clamping space 50, thus locking or unlocking the hexagonal nut 80 continuously.

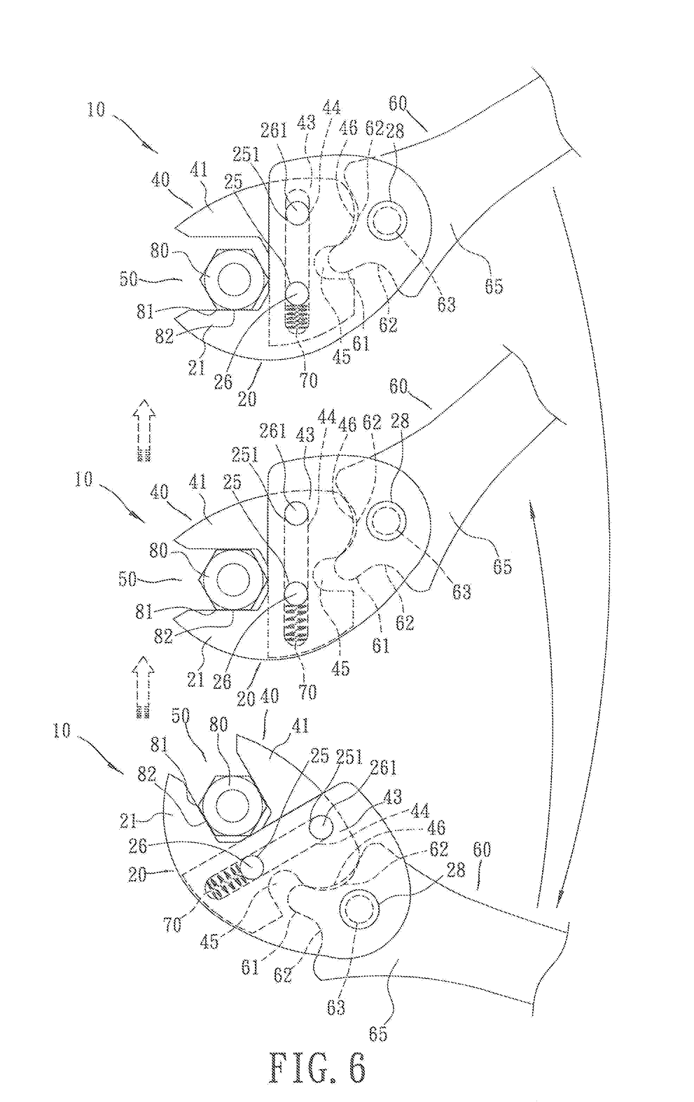

As illustrated in FIG. 6, the handle 60 is manually rotated so as to revolve the operation shaft 65 upwardly along the coupling hole 63, and the actuation shaft 61 and the projection 46 push the second jaw 41 upwardly toward the first jaw 21, hence the width of the clamping space 50 reduces so that the clamping space 50 engages and locks the hexagonal nut 80 until the operation shaft 65 does not rotate. Thereafter, the operation shaft 64 is rotated downwardly along the coupling hole 63, and the actuation shaft 61 and the projection 46 revolve upwardly to push the extension 43, hence the second jaw 41 of the extension 43 moves away from the first jaw 21 so as to increase the width of the clamping space 50 more than a size of the hexagonal nut 80, and the operation shaft 65 is rotated further along the coupling hole 63 so that the second jaw 41 does not engage with the hexagonal nut 80. Preferably, the operation shaft 65 is revolved repeatedly so that the open-end wrench 10 locks or unlocks the hexagonal nut 80 successively.

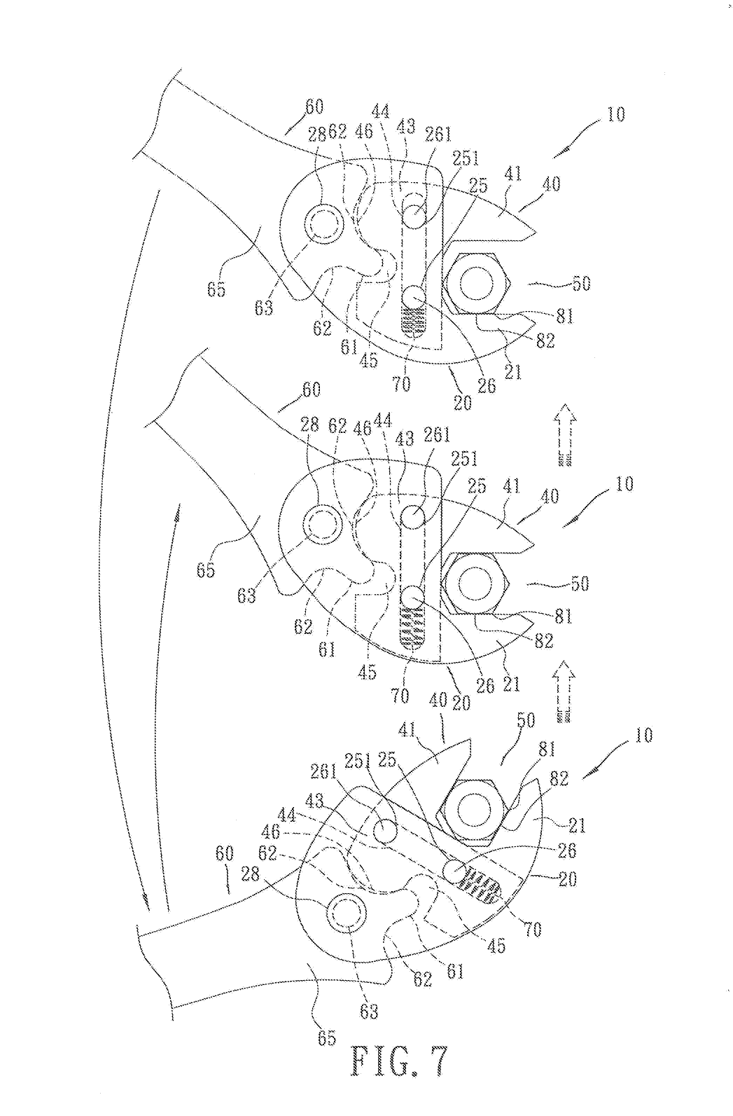

With reference to FIG. 7, the open-end wrench 10 is turned upside down and the handle 60 is rotated so that the operation shaft 65 swivels upwardly along the coupling hole 63, and the actuation shaft 61 and the projection 46 push the second jaw 41 toward the first jaw 21, hence the width of the clamping space 50 decreases so that the clamping space 50 engages the hexagonal nut 80, and the operation shaft 65 is rotated downwardly along the coupling hole 63 so that the actuation shaft 61 and the concaved portion 62 push the extension 43 upwardly, and the extension 43 drives the second jaw 41 to move away from the first jaw 21, thus increasing the width of the clamping space 50 more that the size of the hexagonal nut 80.

Thereafter, the operation shaft 65 is rotated downwardly along the coupling hole 63 so that the second jaw 41 does not engage with the hexagonal nut 80, and the operation shaft 65 is revolved repeatedly, thus unlocking the hexagonal nut 80 quickly.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An open-end wrench being capable of locking and unlocking a hexagon nut continuously and comprising: a holder, a driving head, a returning spring, and a handle;
the holder being configured to accommodate the driving head, the returning spring, and an actuation shaft on a front end of the handle, and the holder including a first jaw extending outwardly from one side of a front end thereof, a body extending outwardly from on a rear end of the first jaw, and an accommodation cavity defined in the body, wherein the accommodation cavity has a first panel arranged therein, the holder further includes a first orifice passing through the body adjacent to the first jaw and includes a second orifice passing through the body away from the first jaw, wherein the first orifice accommodates a first post, and the second orifice houses a second post, the holder further includes a third orifice passing through a rear end of the body so as to accommodate a third post;
the driving head including a second jaw extending outwardly from one side of a front end thereof, and the driving head also including an extension arranged on a rear end of the second jaw, wherein the extension has a second panel formed thereon, a slot defined on a middle section thereof, a trench formed on a rear end thereof, and a projection extending outwardly from the rear end of the extension adjacent to the trench;
the returning spring being accommodated in the slot, and the handle including the actuation shaft arranged on the front end thereof, an operation shaft formed on a rear end thereof, a concaved portion defined on a connection area of the actuation shaft and the operation shaft, and a coupling hole formed thereon proximate to the actuation shaft.

2. The open-end wrench as claimed in claim 1, wherein a clamping space is defined between the first jaw and the second jaw, the actuation shaft is housed in the trench, and the projection is accommodated in the concaved portion.

3. The open-end wrench as claimed in claim 1, wherein the first panel of the accommodation cavity accommodates and mates with the second panel of the extension, hence the second panel moves horizontally on the first panel.
